(19) United States
(12) Patent Application Publication
(10) Pub. No.: US 2004/0064806 A1
(43) Pub. Date: Apr. 1, 2004

(54) Verifiable processes in a heterogeneous distributed computing environment

(75) Inventors: Duncan Johnston-Watt, Kent (GB); Andrew Martin West, Hampshire (GB); Gary Peter Brown, Herts (GB); Stephen Sean Mark Ross-Talbot, West Sussex (GB)

Correspondence Address: BEYER WEAVER & THOMAS LLP, P.O. BOX 778, BERKELEY, CA, 94704-0778, US

(73) Assignee: Enigmatec Corporation

(21) Appl. No.: 10/671,075

(22) Filed: Sep. 25, 2003

Related U.S. Application Data
(63) Continuation-in-part of application No. 10/254,258, filed on Sep. 25, 2002.

(51) Int. Cl. G06F 9/44; H04L 1/22

(52) U.S. Cl. 717/124; 717/126; 714/1

(57) ABSTRACT

There is described a method, computer program product and system which relate to the execution of verifiable processes in a distributed computing/processing environment. More particularly the invention relates to the autonomic implementation and verification of a business logic specification in a heterogeneous distributed computing environment. The business logic specification (102) is rendered (step 112) as a plurality of validated processes (104) for execution in a distributed processing environment (110). By monitoring and analysing the information generated in that execution (step 114), it is possible to correlate a view of the executing processes (106). Comparison between the original specification and the correlated view is performed, context information is applied (step 116) and amendments made to the specification as a result. The invention achieves the full cycle of events substantially autonomically.

This Application is a continuation-in-part of U.S. patent application Ser. No. 10/254,258 filed Sep. 25, 2002, entitled “VERIFIABLE PROCESSES IN A HETEROGENEOUS DISTRIBUTED COMPUTING ENVIRONMENT”, which is hereby incorporated by reference.

1. Field of the Invention

The present invention relates to the execution of verifiable processes in a distributed computing/processing environment. More particularly the invention relates to a method, a computer program product and a system for autonomically implementing and verifying business logic in a heterogeneous distributed computing environment.

The invention enables a high level specification of business logic to be deployed and executed within a distributed processing environment, in a verifiable, controlled and autonomic manner, to ensure that the executing processes correctly implement the original business logic.

2. Background to the Invention

In the following discussion, the term Atesting@ relates to a facility for exercising a component against an expected behaviour. AVerification@ on the other hand is the capability to determine whether the component is valid for execution. References to 3rd Generation Language, or simply 3GL are to conventional compiled programming languages, for example Java, C#, C++ or Ada. XML is the abbreviation for extensible Mark-up Language.

Business logic refers to a representation of any portion of a business procedure. A business procedure could be: a high level business problem, for example the dissemination of a regulatory policy throughout an enterprise; a logistical problem, for example gathering the raw materials to make a certain number of widgets to meet a given deadline; or an infrastructure problem, for example the mediated routing of information flowing through a network.

Business procedures can be represented in a number of alternative notations. Known examples of business logic representations include: canonical XML based representations (for example BPML, ebXML, BizTalk, Xlang, WS-BPEL or WSFL) and proprietary representations (HIPAA, IAA or FIPA).

In the present invention, the term “contextual information” encompasses information about the architecture and services available on a target platform (the combination of hardware processor and operating system), the preferred native language for the target platform and the capabilities of runtime context available on the target platform. Preferably, runtime context is provided to support a standard environment for executables and thus minimise the amount of source code that has to be generated. Runtime context includes, for example: the available programming environments; the available event systems; and accessibility to local files and services and other dependencies in the target platform, such as third party components or legacy systems. An event system is a system that dispatches events in some form, for example Java Message Service, JavaBean Event Listener mechanism, MS Windows or Xwindows event dispatcher.

A network of computing devices at a plurality of sites is termed a distributed network. When the computing devices connected together by a network are of differing types or simply operate according to differing operating systems that network may be described as heterogenous. To take an obvious example, the Internet can thus be viewed as a vast heterogenous, distributed computing network.

The more traditional approach to developing software applications has been to build standalone or client/server solutions. Client/server solutions are clearly appropriate for implementation across networks. These solutions are constrained by the CPU and memory resources upon the computing devices they are running on. Even as computing devices become more powerful, and increase in memory capacity, the complexities of applications will always tend to demand yet more computing power.

Distributed processing architectures were developed as a means of minimizing the constraints of physical computing resources, by enabling the computing power of a larger set of computing devices to be harnessed to implement the tasks traditionally performed by server-centric solutions. Distributed processing/computing environments, in which this power is accessed, have had some notable successes, for example the SETI project.

One ambitious example of a distributed processing environment is the GRID. The GRID is a runtime environment that enables processing tasks to be allocated to computing resources, potentially available across an internet or intranet. To a user, the GRID would appear as a large virtual computing system. The GRID facilitates secure, coordinated resource-sharing between individuals and corporations alike. Standards have been defined in the area of Grid computing (Open Grid Services Architecture), and an organisation has been established to help promote these standards, see http://www.globus.org/.

The constraints of physical computing resources are certainly felt in the arena of business solutions. In response, there has been an increased interest in the benefits of distributed computing environments for business solutions. It is noted that although solutions like the GRID provide an execution environment that is ideal for decomposing business logic and executing it across a wide range of available computing resources, they do not address the management of the business logic that executes within a set of distributed and interacting processes in a manner that is verifiable.

As business logic becomes distributed across many locations, it becomes harder to manage and more difficult to evolve (change) in line with an organisation=s requirements. Changing parts of the logic within a conventional distributed processing environment may have unknown consequences.

Verification is therefore important in ensuring that business logic is executed in a manner that reflects the original intent. Verification also ensures that the business logic representation is valid in the context of the environment within which it executes. This in turn enables the management of changes to the business logic representation to be controlled: the impact that the changes will have on the distributed environment can be suitably evaluated before they are deployed. The end result is more reliable business logic execution.

The prior art approach to the implementation of business logic has been constrained, data- and server-centric. It often requires the presence of human analysts to amend executable code as a result of inconsistencies or error reports.

### SUMMARY OF THE INVENTION

In accordance with the present invention there is provided a method for preparing executables for execution in a distributed processing environment in accordance with a set of process representations of business logic, the method comprising the steps of: providing process representations in a process calculus notation; verifying that the representations are valid; generating executables and corresponding test data in accordance with the verified representations; and testing the executables using the corresponding test data.

The method preferably further comprises the step of deploying the tested executables in the distributed processing environment

It is preferred that the method further comprises the step of monitoring the performance of the deployed executables to gather process execution information.

More preferably the method further comprises the steps of analysing information gathered in the monitoring step; and autonomically altering the executables and corresponding test data in accordance with analysed process execution information.

The step of automatically altering the executables may include altering the generation of executables and test data in accordance with analysed process execution information.

The step of autonomically altering the executables may comprise altering the process representations and repeating the verification, generation and testing steps.

Alternatively it may comprise altering the executables and test data directly and repeating the testing step.

The step of autonomically altering the executables may be performed in accordance with contextual information. Advantageously the contextual information includes heuristics and/or IT (Information Technology) resource requirements.

The generating step preferably generates the executables in accordance with contextual information.

The step of autonomically altering the executables preferably comprises comparing the analysed process execution information with an earlier set of process representations and altering the executables to reduce significant disparities between them.

The generating, testing, analysing and altering steps may be repeated until the comparison indicates the absence of significant disparity.

Advantageously, the executables are generated as source code in a third generation language. The third generation language may be one of the set of languages including C, C++, C#, Ada, Java, Delphi, Visual Basic, and FORTRAN 90.

Preferably the process calculus notation is based upon XML. RIFML is a suitable example of such a process calculus notation.

In a further aspect of the present invention, there is provided a computer program product for preparing executables for execution in a distributed processing environment, the product comprising: a datastore for storing process representations in a process calculus notation; a verification module, for verifying that the representations are valid; a generator module for generating executables and corresponding test data in accordance with the verified representations; and a tester module for testing the executables using the corresponding test data.

In yet a further aspect of the present invention, there is provided a computer system for preparing executables for execution in a distributed processing environment in accordance with a set of process representations of business logic, the system comprising: a datastore for storing process representations in a process calculus notation; a verification module, for verifying that the representations are valid; a generator module for generating executables and corresponding test data in accordance with the verified representations; and a tester module for testing the executables using the corresponding test data.

This present invention is a middleware technology that enables the rapid assembly, testing, verification and deployment of complex business processes, across a heterogenous, distributed runtime environment. It allows these processes to be dynamically updated in response to changing business needs and adapts its runtime environment to approach optimal use of the resources at its disposal and in response to changes in the infrastructure itself.

The present invention therefore seeks to translate a high level process specification into a verified executable form, which can then be executed within a distributed processing environment and monitored to provide feedback that can be used to adapt the runtime environment. By implementing business logic in a verifiable manner, across a distributed processing environment, the invention also enables users to make changes to business logic representations and have those changes reflected across the distributed process environment without impacting existing tasks being performed.

Changes can be implemented as often as necessary in response to changes in infrastructure, business needs and/or feedback from the execution of earlier versions of the executables. In other words, contextual information is used to tailor the executables for delivery, where appropriate, particularly contextual information taking the form of heuristics, (the summed body of knowledge, experience and empirical operational behaviour).

Updated and verified executables are delivered autonomically and substantially independently of the topology or particular implementation.

### BRIEF DESCRIPTION OF THE DRAWINGS

Examples of the present invention will now be described in detail with reference to the accompanying drawings, in which:

FIG. 1 is a block diagram showing an autonomic feedback loop;

FIG. 2 is a block diagram of the steps in the Verification step;

FIG. 3 is a block diagram of the TestCase generation step;

FIG. 4 is a flowchart of the Analysis step; and

FIG. 5 shows an example of a scenario to which the present invention may be applied.

### DETAILED DESCRIPTION

A key concept in the present invention is the concept of autonomic operation. Autonomic computing can be viewed as an approach to self-managed computing systems with a minimum of human interference. By analogy with the human body=s autonomic nervous system, an autonomic computing system seeks to control key functionality without Aconscious awareness or involvement@. Here it is particularly desirable that the need for a conscious human analyst be minimised as the development process proceeds around a development loop.

Throughout this document, a process is defined to be any executable software element, for instance an application, an object, or a component: the terms “port” and “channel” are used to refer to any communication path between two processes.

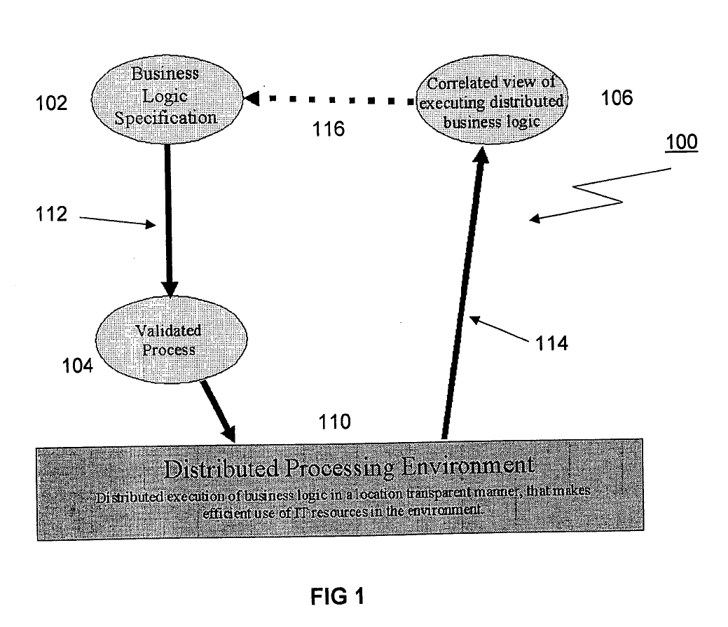

FIG. 1 then shows an autonomic feedback loop 100 in accordance with the present invention. The set of business logic representations, also referred to as the business logic specification 102, is rendered (step 112) as a set of validated processes 104 for execution on a distributed processing environment 110. A correlated ‘view’ 106 of the executing distributed business logic representations is formed.

In order to enhance the execution of the validated processes 104, and to ensure that disparities between the business logic specification 102 and the correlated ‘view’ 106 are reduced, the correlated view 106 and the original business logic specification 102 may advantageously be compared and context information (including heuristic information) may be applied (step 116). The application of context information helps tune the performance, within the context of the distributed processing environment, of the executable forms of the processes 104. This comparison and tuning step (step 116) closes a feedback loop that can be arranged to iterate autonomically.

The present invention discloses the sequence of steps required (step 112) to translate the high level specification 102 into a verified executable form 104.

The first step is business logic verification, where the validity of the business logic specification, the set of business logic representations, within a distributed processing environment is verified.

The verified specification is translated to a format that is executable within a distributed processing environment. The translation step uses contextual information to determine the most appropriate execution representation for the business logic, to ensure it operates efficiently within a distributed processing environment. An example of contextual information is heuristics: heuristics being the body of knowledge, experience and observed operational behaviour. A further example of contextual information is IT resource requirements: where IT resource requirements identify the capabilities an executable process requires from its runtime environment, which may be used to identify the subset of runtime nodes that are capable of supporting those requirements (and therefore executing the process). The translation provides the executable form with instrumentation that enables monitoring and analysis of the business logic, while executing in the distributed processing environment.

The verified executable code is tested against automatically generated test cases. Test cases, based on the original business logic, ensure a complete and thorough testing of the executable form of the business logic is performed. Additional testing may also be performed to exercise specific scenarios, and interact with existing business logic already deployed in the environment.

Further refinements are achieved through the monitoring and analysis of the runtime execution of processes. Any alterations deemed necessary are automatically fed back to the translation and/or verification steps as appropriate.

The aforementioned steps are now explained in more detail:

Business Logic Verification

A pre-requisite for verifying business logic is that the business logic is represented in an appropriate notation. One appropriate formalism for representing business logic that will be executed in a distributed processing environment and allowing subsequent verification is known as Process Calculus. The most prominent example of this type of formalism is known generically as Pi Calculus.

A process calculus enables the interaction, the set of messages and their valid sequences between processes, to be defined formally. The mathematics of process calculi enable two process definitions to be shown, formally to be equivalent (or not) by means of algebraic manipulation.

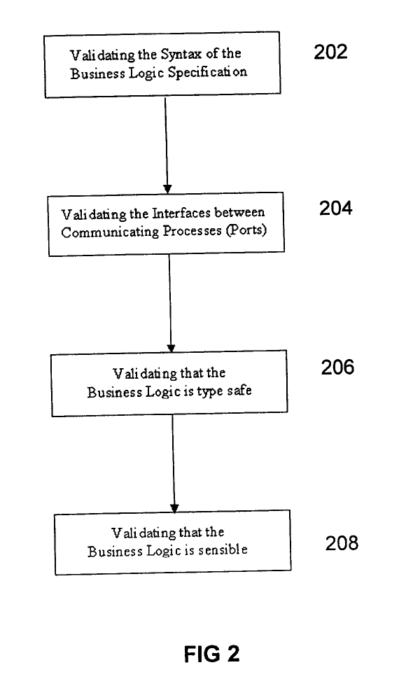

A process calculus also enables the specification of a set of processes that interact in a formal manner. Furthermore, processes can express their interaction with other processes, as well as exchange ports (or channels) and even processes between them. This flexibility is sometimes expressed in terms of the ‘mobility’ of process communication. The stages necessary to verify business logic are described in relation to FIG. 2.

The verification step includes: validation of the syntax of the business logic specification (step 202); validating the interfaces between communicating processes (ports) (step 204); validating that the business logic is type safe (step 206); and validating that the business logic is correct (step 208).

The first level of verification (step 202) is related to the syntax or structure of the business logic specification. If the syntax is not valid, then it will not be possible to proceed with further levels of verification. In cases where the business logic is expressed as XML, the syntax of the business logic can be verified using a standard XML validating parser, with an accompanying DTD or XSchema defined to express what is valid syntax.

A process calculus defines strongly typed interfaces between processes (known as ports or channels). The definition of a type, in the context of such interfaces, includes both static types, which are typical in conventional programming languages (e.g. Java, C#, C++, etc), as well as “behavioural” types, which are based on the externally observable behaviour of processes. It is the use of a behavioural type that allows the capture of the “semantic” interfaces between processes and, indeed, their representation as ports or channels. Processes communicate with each other through these ports or channels, thereby interacting in a semantically correct way with one another.

The next level of verification (step 204) is therefore to ensure that the processes correctly adhere to the type specification associated with the ports they are using and that the message sequences are valid. Additional constraints can be added to further restrict the valid values that may be passed as parameters to operations performed on these ports. Some of these constraints will be verified during this stage of the procedure, while others can only be verified at runtime.

This constraint information can be used by the ‘test case generation’ component to more accurately exercise the business logic being tested. For example, if a parameter represents an ‘integer’ type, then a constraint may be added to ensure that its value is within a pre-defined range. Unless the business logic supplies the parameter value as a static literal value, it will not be possible to determine whether this constraint has been violated during a static analysis of the business logic. Therefore runtime checks will need to be inserted (by the following translation phase) to validate the parameter's value, and generate an exception if an invalid value is supplied.

Further verification can be performed to ensure that the business logic is performing valid tasks with the information (or ‘objects’) that it has access to. A process can receive information as parameters of an operation, by navigating an object model associated with information it has access to, and/or calling methods on ‘objects’ that are within its scope. The business logic will also be able to apply conditions to the ‘objects’ and manipulate the information to derive new information. The validation phase will access meta-information regarding the nature of the information (or ‘objects’) that are being used within the business logic, to determine whether they are of an acceptable type and/or whether they define appropriate methods to support their usage in the business logic.

The validation procedure needs to ensure that for all of the control and manipulation constructs supported by the notation, that the business logic is constrained to only perform tasks in a type safe manner (step 206). For example, conditions that may be used within an “if” or “while” statement must result in a boolean typed value, and arithmetic operations can only be performed on numeric typed variables/values.

The aim of the high level business logic verification, is not only to ensure that it is acceptable in terms of syntax and typing, but also that the business logic (when executed) would perform tasks correctly (step 208), and not result in unnecessary runtime errors. An example of such an error would be the use of local state, or an output port, before it had been initialised. Output ports are retrieved dynamically, from a ‘discovery’ service, and therefore if the port is used before an appropriate discovery or assignment activity is performed, this should be flagged as an error. Otherwise the execution of the business logic would simply result in a runtime error, as no port would be available upon which to perform the relevant operation.

Having a high level specification of the business logic facilitates more comprehensive semantic analysis of the activities.

Translation to an Executable Form

In a distributed processing environment, the context of a given device or node refers to any prevailing conditions that affect that device by virtue of its physical location within a network and the configuration of its software. An important class of contextual information is the body of knowledge, experience and operatively observed behaviour, known as heuristics. As mentioned earlier, IT resource requirements form a further class of contextual information, whereby IT resource requirements identify the capabilities that an executable process requires from its runtime environment. These identified capabilities may be used to identify the subset of runtime nodes that are capable of supporting those requirements (and therefore executing the process).

Verified high level business logic is converted into an executable form that can be deployed and executed in a distributed processing environment. This translation procedure will use contextual information to produce the most appropriate and efficient executable form for the environment into which it will be deployed. Contextual factors that may influence the way in which the translation procedure is performed include: the target programming language used in the distributed processing environment; the types of device used within the distributed processing environment, from multi-processor servers down to personal digital assistants (PDAs); performance statistics gathered from the execution of existing versions of the business logic being translated; IT resource requirements and heuristics (as outlined above).

Business logic (for example, in a canonical XML based process representation) is therefore transformed into executable code using a generator that, amongst other things, selects the appropriate programming language for the target platform and processing environment. The preferred language of the executable code is Java, although other 3GLs are suitable: alternatively object code (binary) may be generated directly. The executable representation thereby generated is appropriate for execution on a distributed processing environment, of which the Java Runtime Environment is an example. This is an example of the autonomic lifecycle management of processes, which optimize the executable representation in accordance with contextual information.

At this point, it is appropriate to detail the structure of the process notation:

Process

This is the high level ‘container’ for the business logic “unit” that will execute within the distributed processing environment, and interact with other processes through ports. To provide the most efficient runtime executable format for the process, it can be translated into, for example, a Java class. The implementation of the class will represent the business logic for that process, and be executed as a set of sub-processes (described below) that react to messages being received on ports associated with the process.

Port Definitions

This section of the specification outlines the ports used by the process. Input ports are used to indicate ports that the process will receive requests from other processes, and output ports define ports upon which this process can make requests to other processes. These ports definitions will be loaded into the translation tool and used to validate any requests to receive or send messages between processes that this process will or could interact with in the runtime environment.

The execution environment will provide the executable version of the process and the means to create and/or retrieve port endpoints, in order to establish communications with other processes. The runtime environment is therefore responsible for managing the communications channels. The process is responsible for enacting the business logic using those ports/channels.

Process Constraints

A process may define a set of constraints that are used to indicate what resources it requires from a runtime environment in order to execute correctly. This information will be used by the distributed processing environment to determine where the process can execute most effectively. If a constraint is specified within the process definition, then it must also be present within the runtime environment within which the process will execute. Dependencies may be related to the environment (for example, the execution language and/or version), or it may relate to system/component dependencies (for instance, a legacy system or a software component—such as a library file or a Java JAR file).

Sub-Processes

The nature of a process is that it reacts to messages (for example, requests, responses, faults and timeouts). Therefore the process can be decomposed into a set of sub-processes that each are responsible for responding to a particular message. Not all messages will be relevant to a process at all times. The process will transition through different states through its lifetime. In any given state a subset of the possible messages that may be received will be of interest. In this respect, the executable form of the business logic can be viewed as implementing a state machine—however, the execution of the state machine revolves around executable sub-processes, as opposed to database-centric manipulation of state tables.

As a sub-process (invoked to handle a particular stimulus) completes its task, it will register interest in the next set of stimuli that are relevant to the process in its current state. Therefore providing the ability to model dynamic state transition behaviour, depending on the business logic encoded within the sub-processes.

In an executable language that supports the concept, a sub-process can be implemented as an “inner class”. This type of class is similar in concept to a normal class, except that it is scoped to the class in which it is defined (which in this case is the process that it belongs to). The translation of sub-processes therefore involves the creation of inner classes, that will be responsible for the execution of any activities (see below) that it represents. The other translation responsibility is to provide the process with the knowledge of how to create the sub process when a relevant stimulus is received.

Activities

Within the scope of a sub-process, is contained the detailed activities that represent the business logic associated with handling the stimulus that caused the sub-process to be activated.

Some of the activities are related to control structures:

(i) Conditional statement—if then else

The conditional expression determines whether the activities associated with the ‘then’ or the optional ‘else’ part will be executed. The conditional expression can be comprised of logical (AND, OR, NOT) and arithmetic operators, applied to variables within the scope. Variables are in scope, either as a result of parameters received from an incoming message, or that are explicitly declared within the sub process.

(ii) Loop constructs

>while= loops are supported to enable contained activities to be performed until a specified conditional expression evaluates to false.

(iii) Throw exceptions

If an error is detected by the business logic, it can cause an ‘exception’ to be created, which will result in the current execution being terminated. Control will either be returned to the runtime environment, or to an exception handler if one has been registered.

Other activities that can be performed include: declaring local variables; assigning information to a variable; retrieving information associated with a variable; calling a method; sending a message; receiving a message; and handling exceptions. Some of the above activities can either be performed on variables that are directly in the scope of the sub-process (in other words, parameters on received messages or declared variables), or in a context that is derived from performing other sets of activities. For example, the business logic can call a method on a declared variable, that returns a value. This value can then be the ‘context’ upon which an assignment is performed. An illustration of this would be calling a method ‘getaccount’ on a variable representing the accounts held by a bank, supplying the customer name as a parameter. The resulting account may then have an assignment activity performed on it, to amend the current balance. Each of these activities can be mapped onto standard programming language constructs.

An example of the type of specification information provided, and the possible structure of the resulting translated class, would be:

<process name=“TradingSystem”>

<ports>

<port name=“TradeEntryPort” type=“input”>

. . . . . .

</port>
<port name=“PrinterPort” type=“output”>

. . . . . . .

</port>

</ports>
<constraint name=“pririter” type=“resource”/>
<subProcess name=“ReceiveTrade”>

<receive port=“TradeEntryPort” operation=“validateTrade”>

. . . . .
<send port=“PrinterPort” operation=“pnnt”>

. . . .

</send>

</receive>

</subProcess>
<subProcess name=“SendNotification”>

. . . . . .
</subProcess>

</process>
would be translated into the form,
public class TradingSystem extends Process {

public TradingSystem(Runtime runtime) {

. . . .

}
public SubProcess getSubProcess(String name) {

if (name.equals(“ReceiveTrade”)) {

return(new ReceiveTrade());

}
. . . . . .

}
public class ReceiveTrade extends SubProcess {

. . . .

}
public class SendNotification extends SubProcess {

. . . .

}

}

The other requirement of the translation procedure is to instrument the executable form. This instrumentation will provide monitoring information about how processes are executing and interacting with each other. This information can be used to support further levels of verification, as well as optimisation of future versions of the executable form.

Monitoring events will be generated to indicate, amongst other things: when messages are passed between process instances; when process instances are created or finished; when state information is updated; when sub processes are fired; or when decision points are evaluated. It is noted that the translation process can either produce directly executable form, or an intermediate version represented in a programming language, which is then compiled into the executable form.

Testing the Executable Form against Automatically Generated Test Cases

One of the problems with testing any software solution is ensuring that the testing has exercised all aspects of the system. Even in projects with rigorous controls, where test cases are specified and developed before the application, it can be possible for the testing to fail to exercise all aspects of a complex system—especially if it is regularly enhanced.

The main reason for this is that it relies on manual processes to determine what testing is required, and then to implement and run those test scenarios. The benefit of building business logic specifications based on formal techniques (in particular, process calculus) is that tools can be developed to analyse the business logic and automatically create relevant tests cases that can then be automatically executed.

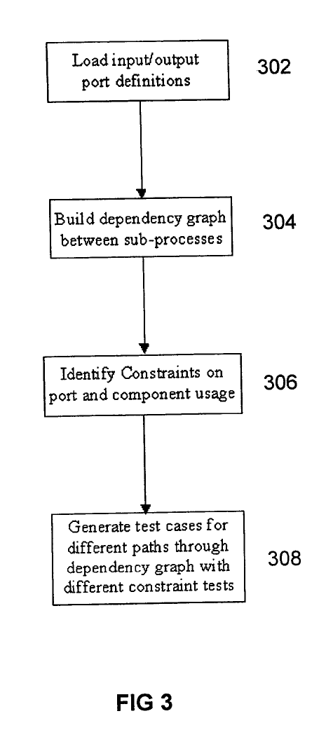

As illustrated diagrammatically in FIG. 3, the first step (step 302) is to understand the input and output ‘interfaces’ associated with the process (or business logic), as these will determine what interactions may be possible with other components in the environment. Input ports can be used to derive requests that will be sent to the process, and output ports can be used to create simulation processes that will emulate the behaviour of those associated processes. These simulated process will be generated to respond in an appropriate manner, depending on the test case being executed.

At its highest level, the test case generator will produce at least one test case per potential path through the business logic. This means that any conditional statements need to analysed to determine what information is required to ensure a true and false value for the condition. The dependency graph derived from the way in which sub-processes interact will also be used to generate the set of potential paths through the business logic (step 304).

Constraints upon port and component usage are identified (step 306). As more detailed constraint information is defined, for example, associated with the parameters defined for an operation on a port, then more detailed test cases can be constructed to exercise different paths through the dependency graph with different constraint tests including the testing of minimum and maximum extreme values (step 308).

Monitoring information, generated from the instrumented executable form of the business logic, can be used to trace the path of execution associated with each test case against the expected behaviour.

Analysing the Runtime Execution of Processes

The instrumentation information generated by the distributed processing execution of the business logic specification deployed into the distributed processing environment can be analysed to correlate activity between communicating process instances (step 114 in FIG. 1). This information can be derived from the messages that are sent and received by the process instances.

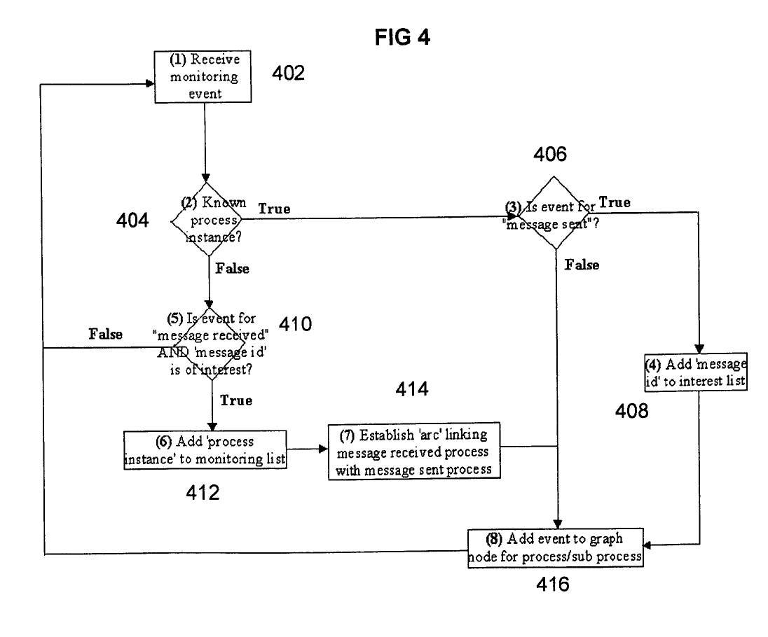

An interaction graph, FIG. 4, can be constructed, firstly to identify the connections between these process instances, but more importantly to enable metric information to be derived which can be used to optimise the way business logic is being executed in the distributed environment.

The interaction graph illustrated in FIG. 4 starts with the reception of monitoring events 402. Events can be received statically (that is to say, as the result of queries on a historic database of recorded monitoring events) or dynamically in Arealtime@, while the associated processes are executing.

The process instance is then checked to determine whether the record belongs to a process instance already being monitored 404. If it is already being monitored it will already be part of the monitoring graph.

Where the process is already being monitored, then we need to check if the monitoring event indicates that a message is being sent 406. And if a message is being sent, the message id should be added to a list of interest 408, thereby ensuring that information about the process instance that is going to receive the message is captured, and highlighting an inter-process connection in the monitoring graph being constructed.

If the process instance, associated with the monitoring event, is not currently being monitored then the monitoring event would be of no interest unless it belonged to a process instance that receives a message previously sent by a process of interest 410. Only then will the ‘process instance’ be added to the monitoring list 412. An association between process instances will be created by virtue of the process instance receiving a message from another process that is already being monitored. The association between process instances establishes a communication path between the two process instances, which means that any subsequent monitoring events for the ‘receiving’ process instance should now be captured as well, thereby establishing an ‘arc’ linking the message received process with the message sent process 414.

Provided the monitored event is either already monitored or recently added to the monitoring list, it must be ensured that each of the monitoring events is associated with the process and sub-process nodes that they relate to 416. This means that performance information can be derived from the activities associated with each node, as well as the interactions between the process instances, for example the latency of the request/response, or the percentage of time taken in each of the processes.

Although the interaction graph (constructed using the procedure shown in FIG. 4) can be beneficial in its own right, as a way of tracing through the execution of a particular business transaction across potentially many processes, it also can be used for two higher level purposes: as a final verification of the business logic and in order to improve the executable form.

Final verification involves a comparison between actual performance and the originally specified goals (step 116 of FIG. 1). The interaction graph describes how multiple processes (and sub-processes) interacted to achieve a specific business transaction. To enable this information to be compared against the original business logic specification, the relevant parts of the interaction graph associated with the business logic representation (or process) of interest are extracted. Within the context of this process, the interaction graph can then be examined from the point where the process instance is created, through its transition through one or more sub-processes, to its conclusion. Depending on the nature of the process, and the duration of the interaction graph that has been captured, the verification of the business logic specification may not extend to the conclusion of the process. However, the verification will proceed as far as it can, checking that the correlated monitoring information correctly identifies a path through the business logic specification, along with relevant state changes and decision points.

Using the interaction graph to improve the executable form relies on the graph=s ability to break information down process by process. Metrics can be obtained, related to the duration spent performing any particular task and the time spent delegating parts of the task to other process instances. This means that a breakdown of activity can be derived showing how much time was actually spent within the process instance, how much time was spent in the process instances that were interacted with as part of the processing, and significantly, how much (latency) time was spent in passing the requests between the process instances. This information can be used to determine whether the executable form of a set of processes should be decomposed in a different manner, so that where a significant volume of requests are being passed between two business logic representations, they can be re-deployed in a co-located manner to reduce the overall time to exchange requests.

Similarly, it may be found that a single process (and associated business logic) can be decomposed into sub-components, where each component can be more appropriately co-located with the resources that they require. A prime example of this would be a process that includes many interactions with a user, followed by many interactions with a resource (for example, a legacy system or database). If the process is co-located with the user, then the access to the resource will be inefficient, and vice versa. Therefore if the process can successfully be decomposed, the user intensive activity can reside close to the user, and then the relevant information can be sent in a single request to the other decomposed process which would be co-located with the resource.

The preferred environment for the present invention is referred to by the acronym RIF, the Reactive Intelligence Framework. Using RIF, a business can implement business logic in a verifiable and autonomically updated manner.

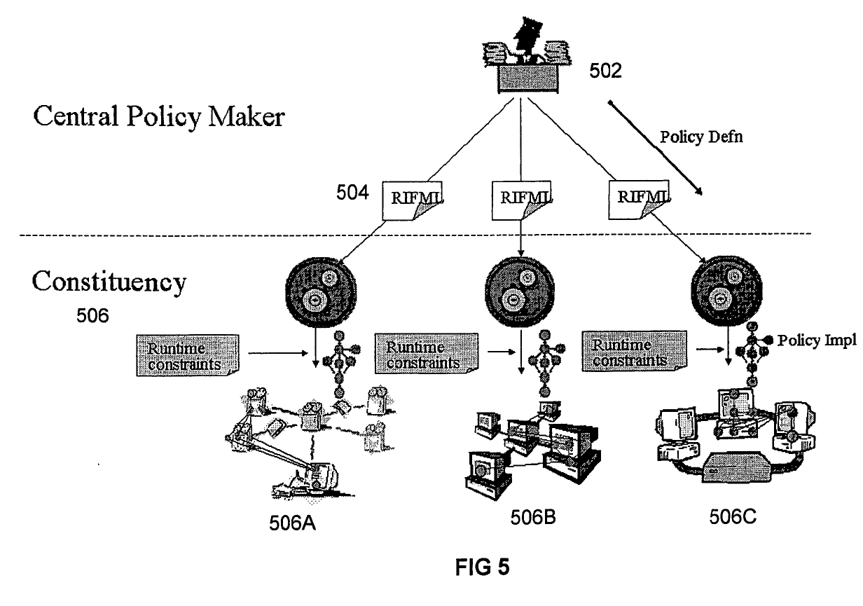

An illustrative scenario is shown in FIG. 5. The scenario is based on a “central policy maker” 502 who is responsible for determining policy. The business logic of this scenario can be specified in the RIF distributed processing environment. Policy is encoded in a declarative XML form that maps directly to a process specification in RIF, RIF markup language (RIFML) 504. The policy maker 502 delivers the policy to those entities 506A-C that must implement the policy (hereinafter referred to generally as the “constituency”). AConstituents@ 506A-C then have a responsibility for adhering to (or implementing) that policy.

The central policy maker might be a regulatory body or some compliance department in an enterprise. The constituency might correspond to an enterprise policed by a regulator or a department within an enterprise. Whether regulatory body or compliance department, the policy maker 502 delivers policy to a constituency 506 and that the constituents 506A-C operate different IT infrastructures (by which we mean computational resources connected to a network and suitable software to support the business functions), making them both heterogeneous and semi-autonomous. The central policy maker 502 cannot enforce how policy is implemented only stipulate what that policy is.

What the central policy maker 502 needs to know is that the policy as described is being properly implemented over the differing IT infrastructures of the constituency. Whilst a policy says what is permissible it does not say how it should be implemented. The challenge is to be able to prove formally that an implementation of a policy is the same as the central policy maker has defined. The solution must lead to a consistent policy management in a dynamic situation.

The central policy maker=s notion of what the policy is and a constituent's implementation of the same policy may diverge, for example in the area of legacy systems. Consider the situation where an incorrectly modelled wrapper for a legacy system results in a message exchange that is invalid, where invalid means invalid against the central policy makers definition of that policy. This might happen due to a timing issue when wrapping a synchronous system into an asynchronous message-passing infrastructure. This would result in monitoring information from the execution of the distributed processes being compared against the original business logic (i.e. the policy as defined by the central policy maker). This would highlight any differences between the required behaviour and the implementation of the policy and so enable the translation mechanism to be autonomically changed so that the correct behaviour can be ensured without the need for a human analyst to amend either business logic representation or executable.

We claim:

1. A method for preparing executables for execution in a distributed processing environment in accordance with a set of process representations of business logic, the method comprising the steps of:
providing process representations in a process calculus notation;
verifying that the representations are valid;
generating executables and corresponding test data in accordance with the verified representations; and
testing the executables using the corresponding test data.

2. A method according to claim 1, further comprising the step of deploying the tested executables in the distributed processing environment.

3. A method according to claim 2, further comprising the step of monitoring the performance of the deployed executables to gather process execution information.

4. A method according to claim 3, further comprising the steps of analysing information gathered in the monitoring step; and autonomically altering the executables and corresponding test data in accordance with analysed process execution information.

5. A method according to claim 4, wherein the step of autonomically altering the executables includes altering the generation of executables and test data in accordance with analysed process execution information.

6. A method according to claim 4, wherein the step of autonomically altering the executables comprises altering the process representations and repeating the verification, generation and testing steps.

7. A method according to claim 4, wherein the step of autonomically altering the executables is furthermore performed in accordance with contextual information.

8. A method according to claim 7, wherein the contextual information includes heuristics.

9. A method according to claim 1, wherein the step of generating the executables is furthermore performed in accordance with contextual information.

10. A method according to claim 4, wherein the step of autonomically altering the executables comprises altering the executables and test data directly and repeating the testing step.

11. A method according to claim 4, wherein the step of autonomically altering the executables comprises comparing the analysed process execution information with an earlier set of process representations and altering the executables to reduce significant disparities between them.

12. A method according to claim 11, further comprising the step of repeating the generating, testing, analysing and altering steps until the comparison indicates the absence of significant disparity.

13. A method according to claim 1, wherein the executables are generated as source code in a third generation language.

14. A method according to claim 13, wherein the third generation language is one of the set of languages including C, C++, C#, Ada, Java, Delphi, Visual Basic, and FORTRAN 90.

15. A method according to claim 1, wherein the process calculus notation is based upon XML.

16. A method according to claim 13, wherein the process calculus notation is RIFML.

17. A computer program product for preparing executables for execution in a distributed processing environment in accordance with a set of process representations of business logic, the product comprising:
a datastore for storing process representations in a process calculus notation;
a verification module, for verifying that the representations are valid;
a generator module for generating executables and corresponding test data in accordance with the verified representations; and,
a tester module for testing the executables using the corresponding test data.

18. A computer program product according to claim 17, wherein the tester module allows the tested executables to be deployed in the distributed processing environment.

19. A computer program product according to claim 18, further comprising a monitor module, for monitoring the performance of the deployed executables to gather process execution information.

20. A computer program product according to claim 19, further comprising an analyser module for analysing process execution information gathered by the monitor module and an update module, which alters the executables and corresponding test data autonomically in accordance with analysed process execution information.

21. A computer program according to claim 20, wherein the autonomic alteration of the executables and corresponding test data includes alteration of the behaviour of the generator module in accordance with analysed process execution information.

22. A computer program product according to claims 20, wherein the update module autonomically alters the executables and corresponding test data by altering the process representations and instigating the sequential operation of the verification module, the generator module, the tester module and the analyser module.

23. A computer program product according to claims 20, wherein the update module autonomically alters the executables in accordance with contextual information.

24. A computer program product according to claim 23, wherein the contextual information includes heuristics.

25. A computer program product according to claim 15, wherein generator module generates the executables in accordance with contextual information.

26. A computer program product according to claim 20, wherein the update module autonomically alters the executables and corresponding test data by altering the executables and test data directly and instigating the operation of the tester module and the analyser module.

27. A computer program product according to claim 20, wherein the update module autonomically alters the executables and corresponding test data by comparing the analysed process execution information with the earlier set of process representations and altering the executables to reduce significant disparities between them.

28. A computer program product according to claim 20, wherein the sequential operation of the verification module, the generator module, the tester module, the analyser module and the update module continues autonomically until the comparison indicates the absence of significant disparity.

29. A computer program product according to claim 17, wherein the executables are generated as source code in a third generation language.

30. A computer program product according to claim 29, wherein the third generation language is one of the set of languages including C, C++, C#, Ada, Java, Delphi, Visual Basic, and FORTRAN 90.

31. A computer program product according to claim 17, wherein the process calculus notation is based upon XML.

32. A method according to claim 31, wherein the process calculus notation is RIFML.

33. A computer system for preparing executables for execution in a distributed processing environment in accordance with a set of process representations of business logic, the system comprising:
a datastore for storing process representations in a process calculus notation;
a verification module, for verifying that the representations are valid;
a generator module for generating executables and corresponding test data in accordance with the verified representations; and
a tester module for testing the executables using the corresponding test data.

34. A computer system according to claim 33, wherein the tester module allows the tested executables to be deployed in the distributed processing environment.

35. A computer system product according to claim 18, further comprising a monitor module, for monitoring the performance of the deployed executables to gather process execution information.

36. A computer system product according to claim 19, further comprising an analyser module for analysing process execution information gathered by the monitor module and an update module, which alters the executables and corresponding test data autonomically in accordance with analysed process execution information.

37. A computer system according to claim 20, wherein the autonomic alteration of the executables and corresponding test data includes alteration of the behaviour of the generator module in accordance with analysed process execution information.

38. A computer system according to claim 36, wherein the update module autonomically alters the executables and corresponding test data by altering the process representations and instigating the sequential operation of the verification module, the generator module, the tester module and the analyser module.

39. A computer system according to claims 36, wherein the update module autonomically alters the executables in accordance with contextual information.

40. A computer system according to claim 39, wherein the contextual information includes heuristics.

41. A computer program product according to claim 33, wherein generator module generates the executables in accordance with contextual information.

42. A computer system according to claim 36, wherein the update module autonomically alters the executables and corresponding test data by altering the executables and test data directly and instigating the operation of the tester module and the analyser module.

43. A computer system according to claim 36, wherein the update module autonomically alters the executables and corresponding test data by comparing the analysed process execution information with the earlier set of process representations and altering the executables to reduce significant disparities between them.

44. A computer system according to claim 43, wherein the sequential operation of the verification module, the generator module, the tester module, the analyser module and the update module continues autonomically until the comparison indicates the absence of significant disparity.

45. A computer system according to claim 33, wherein the executables are generated as source code in a third generation language.

46. A computer program product according to claim 45, wherein the third generation language is one of the set of languages including C, C++, C#, Ada, Java, Delphi, Visual Basic, and FORTRAN 90.

47. A computer program product according to claim 33, wherein the process calculus notation is based upon XML.

48. A method according to claim 47, wherein the process calculus notation is RIFML.

49. A method for verifying and implementing process representations of business logic for execution in a distributed processing environment, the method comprising:
providing process representations in a process calculus notation;
verifying that the representations are valid;
generating executables and corresponding test data in accordance with the verified representations;
testing the executables using the corresponding test data;
analysing process execution information; and
autonomically altering the executables and corresponding test data in accordance with said analysed process execution information.

50. A computer program product for verifying and implementing process representations of a business logic in a distributed processing environment, the product comprising:
means for storing process representations in a process calculus notation;
means for verifying that the representations are valid;
means for generating executables and corresponding test data in accordance with the verified representations;
means for testing the executables using the corresponding test data;
means for analysing process execution information; and
means for altering the executables and corresponding test data autonomically in accordance with analysed process execution information.

51. A computer system for verifying and implementing process representations of business logic in a distributed processing environment, the system comprising:
means for storing process representations in a process calculus notation;
means for verifying that the representations are valid;
means for generating executables and corresponding test data in accordance with the verified representations;
means for testing the executables using the corresponding test data;
means for analysing process execution information; and
means for altering the executables and corresponding test data autonomically in accordance with analysed process execution information.
